(19) United States
(12) Patent Application Publication
(10) Pub. No.: US 2015/0304255 A1
(43) Pub. Date: Oct. 22, 2015

(54) SYSTEMS AND METHODS FOR MODIFYING CONTENT OF A MESSAGE INTENDED FOR A PLURALITY OF RECIPIENTS

(71) Applicant: CONVERSEPOINT LLC, Chicago, IL (US)

(72) Inventors: Randall G Menna, Chicago, IL (US); Peter Kelso, Chicago, IL (US)

(73) Assignee: ConversetPoint LLC, Chicago, IL (US)

(21) Appl. No.: 14/648,635

(22) PCT Filed: Nov. 29, 2013
(86) PCT No.: PCT/US2013/072509

§ 371 Date: May 29, 2015

Related U.S. Application Data
(60) Provisional application No. 61/732,228, filed on Nov. 30, 2012.

(51) Int. Cl. H04L 12/58; G06Q 50/34

(52) U.S. Cl. CPC H04L 51/066; G06Q 50/34

(57) ABSTRACT

Systems and methods are provided for facilitating an exchange in a messaging conversation between an originating entity and a plurality of recipient entities. According to certain aspects, a facilitating entity receives a message from the originating entity that is intended for the plurality of recipient entities. The facilitating entity analyzes the message to determine how to modify content associated with the message and modifies the content of the message according to the analysis. The facilitating entity sends the modified message to the plurality of recipient entities, hi aspects, the facilitating entity can manage rounds of message and response exchanges with one or more of the recipient entities until a predefined criteria is met, or according to other parameters.

### CROSS-REFERENCE TO RELATED APPLICATION

This international application claims priority to U.S. Provisional Application No. 61/732228, filed Nov. 30, 2012, which is incorporated herein by reference in its entirety.

### FIELD

This application generally relates to facilitating a message intended for a plurality of recipient entities. In particular, the application relates to platforms and techniques for modifying content of the message intended for the plurality of recipient entities based on an analysis the message.

### BACKGROUND

With the increasing prevalence of devices and technology offering messaging and general communication capabilities, individuals are able to more easily and frequently communicate with contacts and other individuals. For example, individuals can send emails, text messages, and other data communications to recipients. With the advancing growth of smart phones, there is an ongoing shift in communications from personal messages to group communication. Particularly, in personal messaging, one party communicates with another party and they engage in an exchange of information. In group communication, one party communicates with a group of individuals, also for the purpose of exchanging information,

However, deficiencies exist in current group communication technologies and protocols. In particular, simply mapping the techniques of personal messaging to a group does not scale in effectiveness and efficiency. For example, getting the right information to the right individuals, ensuring that the right individual is in the conversation, not overloading certain individuals with useless or irrelevant information, and modifying messages into a format or to contain information that can be readily interpreted or understood by the recipients are all challenges that are not addressed by current group communication technologies.

Accordingly, there is an opportunity to develop techniques for making group communication effective, efficient and reliable. In particular, there is an opportunity to develop techniques for modifying content of a message intended for a group of recipients to ensure that the recipients receive relevant and tailored messages. Further, there is an opportunity to develop techniques for facilitating group message exchange to reduce the amount of message content that the sender needs to compose and reduce the amount of response messages that are communicated to the sender.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 illustrates an existing data communication pattern in accordance with some Embodiments.

FIG. 2 illustrates an exemplary data communication pattern in accordance with some embodiments.

FIG. 3 illustrates an exemplary application of the message facilitation techniques in accordance with some embodiments.

FIG. 4 illustrates an exemplary application of the message facilitation techniques in accordance with some embodiments.

FIG. 5 illustrates an exemplary application of the message facilitation techniques in accordance with some embodiments.

FIG. 6 is a block diagram of a device in accordance with some embodiments.

FIG. 7 is a flow diagram depicting message facilitation in accordance with some embodiments.

### DETAILED DESCRIPTION

The present embodiments are defined by the appended claims. This description summarizes some aspects of the present embodiments and should not be used to limit the claims.

Systems and methods are disclosed for facilitating conversational or group messaging, wherein participant entities can exchange messages and message responses in one or more sets or rounds. Contrary to conventional messaging, the systems and methods as described herein describe a facilitating entity capable of analyzing messages associated with the conversation and modifying content of the messages according to the analysis. Using the facilitating entity, the embodiments create conversation construction patterns that may encompass multiple rounds, and where the message facilitation can be directed according to logic, state, and instruction.

The systems and methods support control of message routing and distribution via intercepting messages, analyzing messages, and modifying message content. Particularly, logic and other evaluative techniques can be used to analyze individual and collected messages, message data, and message metadata according to predefined criteria and other parameters. The systems and methods can advantageously make group messaging techniques more effective, efficient and reliable. For example, the facilitating entity, after analyzing a message, can modify the metadata or the content of the message to better tailor the message for the specified recipients, such as by increasing the priority of the message, adding information from other applications or systems, removing confidential or sensitive information, adding certain information, or performing other modifications. It should be appreciated that the entities as discussed herein can be a human, a system, a system acting on behalf of a human, a corporation, a company, an enterprise, or other types of entities.

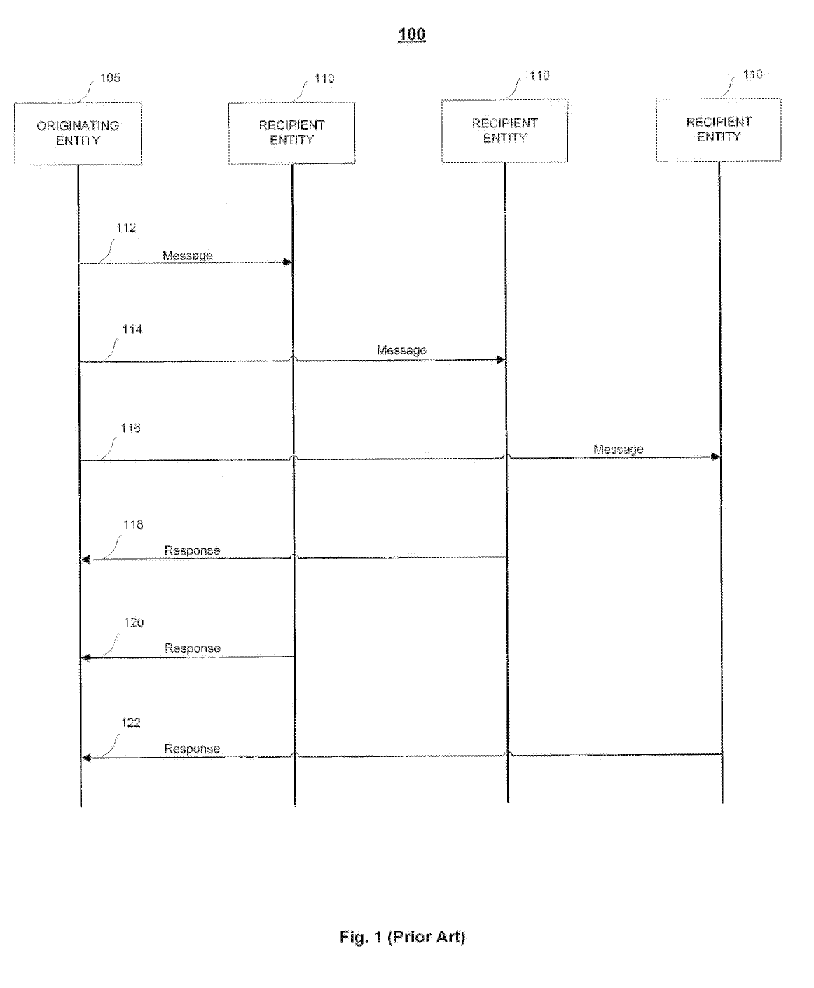

Referring to FIG. 1, depicted is a currently existing communication technology pattern 100 related to sending a message to a plurality of recipient entities. As shown in FIG. 1, the pattern 100 includes an originating entity 105 and three (3) recipient entities 110, wherein the originating entity 105 has a message that it intends to send to each of the recipient entities 110.

The originating entity 105 sends 112, 114, 116 the message to each of the recipient entities 110. Particularly, the message that is received by the recipient entities 110 is the same message that is sent by the originating entity 105; without any modification of content associated with the message. As shown in FIG. 1, the originating entity 105 receives 118, 120, 122 various responses from each of the recipient entities 110. For example, the responses can be direct responses to the message sent to the recipient entities 110.

However, there are drawbacks to the existing communication pattern 100 as detailed in FIG. 1. Particularly, the content of the message is only tailored to the extent that the originating entity 105 chooses. Accordingly, there is no opportunity to modify any content associated with the message before it is sent to the recipient entities 110. For example, if the message includes a survey with a number of possible selection options, the message may not be in a correct or efficient format, or may not include information helpful to the recipient entities 110, when it is received by the recipient entities 110. As a result, the recipient entities 110 may not be able to respond to the survey in an effective manner or even access the survey. Further, the originating entity 105 is not able to modify metadata associated with the message because the message is transmitted according to the communication protocol used to facilitate the delivery of the message. For example, an individual may want to anonymize the message so that his or her identifying information is not included in the message.

Still further, the message may need to include certain information that the originating entity 105 may not have readily available, such as disclaimers, signatures, and other data. Moreover, the message may include information that is not intended for one or more of the recipient entities 110. For example, the message may contain sensitive content that the one or more of the recipient entities 110 is not authorized to view. Further still, the originating entity 105 may not want to receive a response until a certain criteria is met.

Accordingly, there is an opportunity to perform an analysis on a message from an originating entity to determine how to modify content of the message before the message is sent to the recipient entities. As discussed herein, the analysis and the modification can be based on a variety of factors. Further, there is an opportunity to perform an analysis on any return message to determine whether a criteria is met, and optionally further modify the message and send the further modified message to the recipient entities if further response is needed.

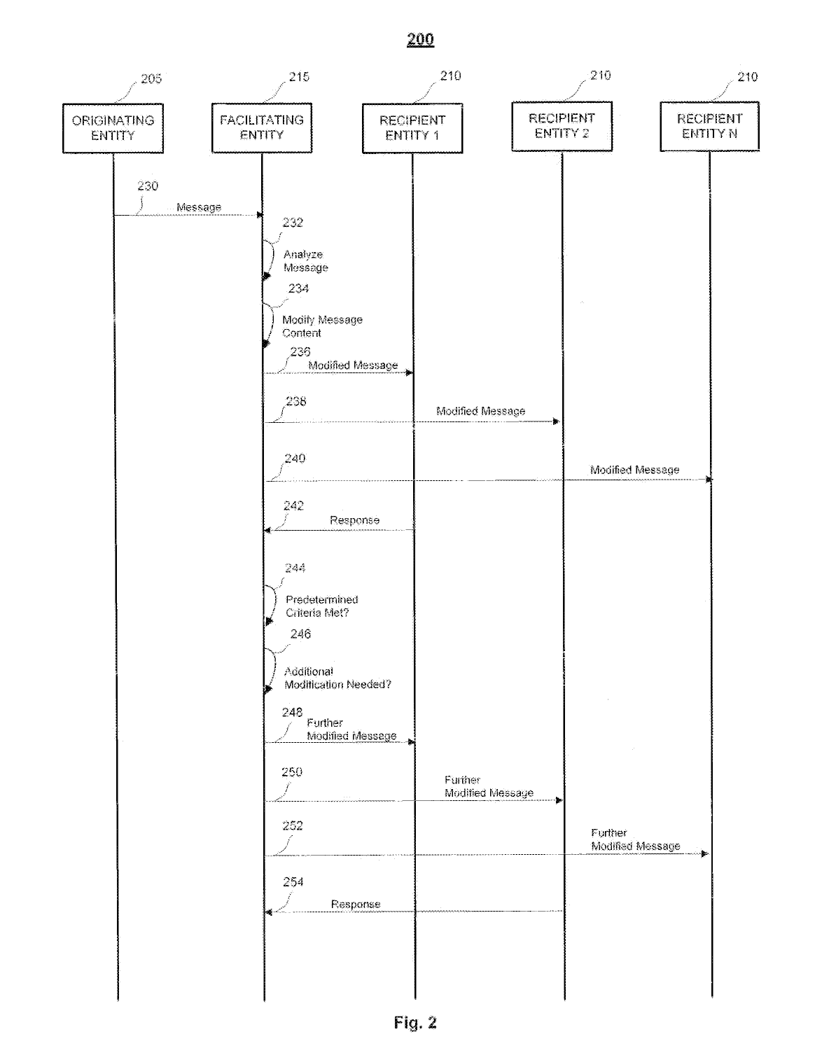

Referring to FIG. 2, depicted is a communication pattern 200 detailing the present embodiments. Similar to the communication pattern 100 of FIG. 1, the communication pattern 200 includes an originating entity 205 and three (3) recipient entities 210. The communication pattern 200 further includes a facilitating entity 215 capable of facilitating messages between the originating entity 205 and the recipient entities 210. It should be understood that the facilitating entity 215 can include any combination of hardware and software capable of performing the functionalities as discussed herein. For example, the facilitating entity 215 can be any type of computer, server, or the like. Further, it should be understood that a user can interface with the facilitating entity 215 to provide input for any of the functionalities as discussed herein.

As shown in FIG. 2, the originating entity 205 can send 230 a message to the facilitating entity 215. In embodiments, the message can be any type of data capable of being communicated such as, for example, e-mails, text messages (e.g., SMS, MMS, etc.), voice-to-text messages, electronic documents, or other data types. Further, the message can include content that can be any combination of metadata, body content, header information, and/or the like.

The facilitating entity 215 can analyze 232 the message to determine how to modify the content associated with the message. For example, the analysis can be based on metadata of the message, such as a priority of the message (e.g., low, high, etc.), the identifying data (e.g., sender, recipients, etc.), and other metadata fields. In some cases, in the analysis, the facilitating entity 215 can examine the message to identity the recipient entities 210 that are specified to receive the message, and can determine the content modification accordingly. For example, the facilitating entity 215 can determine that some of the content of the message is sensitive and should not be reviewed or otherwise seen by one of more of the recipient entities 210. In still other cases, the facilitating entity 215 can scan the message, such as via a lexical analysis, to determine that certain content needs to be removed or added. For example, the message may indicate that certain lab results are included in the message, but the message as sent from the originating entity 205 lacks the lab results. Accordingly, the facilitating entity 215 can determine that the lab results need to be retrieved, and can retrieve the lab results and insert them into the message.

In embodiments, the message can be a solicitation for bids from the recipient entities 210. For examples the message can indicate a product or service up for bid or auction, a minimum bid requirement, a reserve price, and/or other parameters. In analyzing the message, the facilitating entity 215 can identify the relevant parameters specified by the message and can determine how to modify the content of the message based on the parameters. For example, the facilitating entity 215 can determine to modify the message content into a particular format that outlines one or more of the parameters. For further example, the facilitating entity 215 can determine to modify the message into a format that allows selection or input from the recipient entities.

Further, in embodiments, the facilitating entity 215 can analyze the message to determine an option choice selection and presentation style for the modified message. For example, the modified message can be in the form of a survey from which the originating entity 205 is soliciting responses. Particularly, the option choices can be enumerated options, open options, validated options, unvalidated options, and/or other options. Further, the presentation styles can be single selection, multiple selection, simple unary, weighted unary, simple binary, weighted binary, simple integer range, and/or other styles.

According to some embodiments, the analysis of the message can be performed via user interaction. More particularly, a user can interact with the facilitating entity 215 to examine the message and determine how to modify the content of the message. In some cases, the facilitating entity 215 can prompt the user with various options to select bow to modify the message content. In other cases, the user can manually modify the message and provide the modified message to the facilitating entity 215. It should be appreciated that other techniques and interactions with the user for analyzing and modifying the content of the message are envisioned.

The facilitating entity 215 can modify 234 the message content according to the analysis. For example, the facilitating entity 215 can modify the message metadata, the body of the message, and/or other message content. In some cases, the message content modification can be performed in response to receiving various input from a user. The facilitating entity 215 can send 236, 238, 240 the modified message to each of the recipient entities 210. In embodiments, the modified message can be sent according to any communication protocol. After sending the modified message, the facilitating entity can receive 244 a response from one of the recipient entities 210. For example, in the case as shown in FIG. 2, the response is received from recipient entity 1. Although not shown in FIG. 2, it should be appreciated that other responses can be received from others of the recipient entities 210.

The facilitating entity 215 can determine 244 if a predefined criteria has been met. In embodiments, the predefined criteria can be based on one or more factors relating to the responses or the communication in general. For example, the predefined criteria can be an amount of time allotted for responses from the recipient entities 210 to be received. The amount of time can be a fixed amount of time or can be formulaically determined based on various factors. For further example, the predefined criteria can be based on an amount or percentage of the recipient entities 210 who respond. For instance, the predefined criteria can be met if the facilitating entity 215 receives responses from at least 50% of the recipient entities 210. For further instance, the predefined criteria can be met if the facilitating entity 215 receives a single response, receives multiple responses, receives a response with certain content, or receives one or more responses from one or more specific recipient entities. It should be appreciated that other predefined criteria are envisioned. In embodiments, if the predefined criteria is met, the facilitating entity 215 can terminate the conversation. In some cases, the facilitating entity 215 can send any received responses, a summary report, and/or other content to the originating entity 205.

If the predefined criteria is not met, the facilitating entity 215 can determine if an additional modification is needed. Particularly, any responses received from the recipient entities 210 may not have been sufficient and the facilitating entity 215 can determine that one or more extra rounds of message exchange are needed. For example, the facilitating entity 215 can determine that the number of selection options in the message needs to be modified, that the format (e.g., open, enumerated, etc.) of the message needs to be changed, and/or other modifications or changes.

If no additional modification is needed, then the facilitating entity 215 can terminate the conversation, wait for more responses, or perform other functions. If additional modification is needed, then the facilitating entity 215 can modify the message accordingly and send 248, 250, 252 the further modified message to the recipient entities 510. The facilitating entity can receive 254 a response from one of the recipient entities 210, in this case recipient entity 2. Although not shown in FIG. 2, it should be appreciated that other responses can be received from others of the recipient entities 210. Further, although not shown in FIG. 2, the facilitating entity 215 can analyze the response and determine if a predefined criteria is met and/or if additional modification is needed, as discussed herein, and can send additional messages to the recipient entities 210 where necessary.

Further embodiments envision multiple facilitating entities 215. For example, a first facilitating entity can perform an analysis on the message received from the originating entity 205 and send the message and analysis to an additional facilitating entity for further analysis and/or to modify the message. It should be appreciated that the multiple facilitating entities 215 can perform functionalities in parallel or in sequence.

Still further embodiments envision the facilitating entity 215 invoking various systems or applications in response to various triggers. For example, the various systems and applications can be billing systems, calendaring systems, external delivery systems, archiving systems, and others. Further, the triggers can be related to the content of the original message received from the originating entity 205 or can be based on the responses received from the recipient entities. In some cases, the triggers can be in response to the conversation terminating. It should be appreciated that other various systems, applications, and triggers are envisioned.

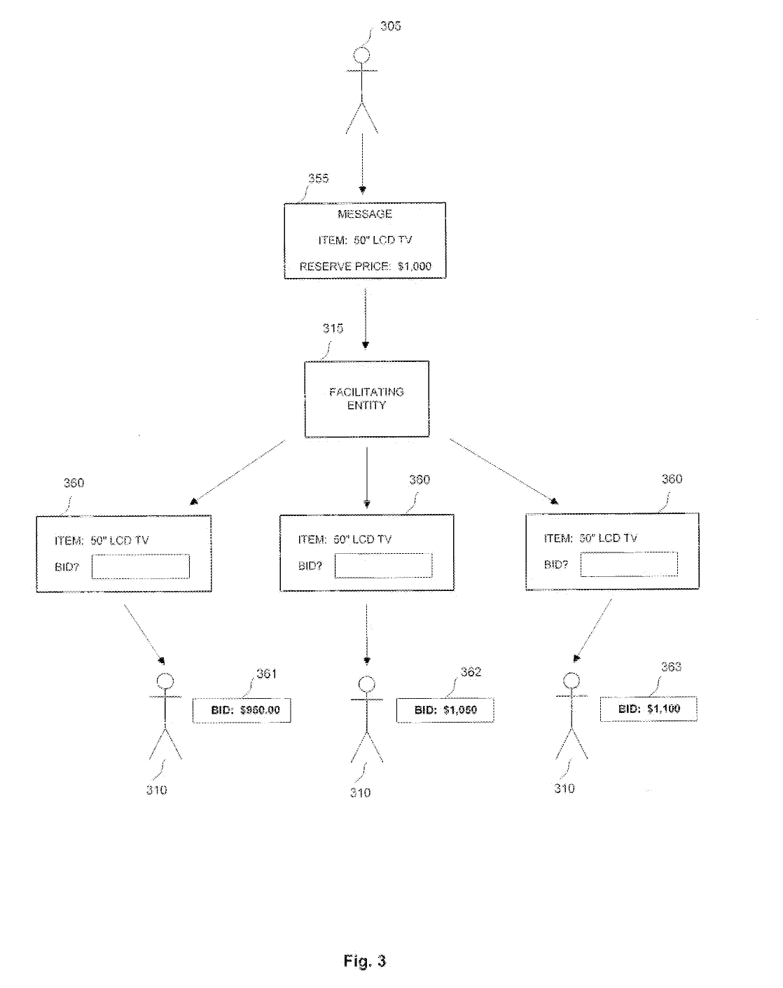

Referring to FIG. 3, depicted is an exemplary application of the functionalities as described herein. In particular. FIG. 3 depicts a bid pattern situation wherein an originating entity 305 wishes to solicit bids for an item from a group of recipient entities 310.

As shown in FIG. 3, the originating entity 305 can send a message 355 to a facilitating entity 315. The message 355 can indicate a product up for bid (as shown: a 50′ LCD TV) and a bid requirement (as shown: a reserve price of $1,000). Particularly, the bid requirement can correspond to a parameter that the facilitating entity 315 can use to determine if a particular bidding round, or the bidding conversation in general, can complete or terminate. For example, if the facilitating entity 315 determines that the bid requirement is fulfilled, then the facilitating entity 315 can terminate the group conversation, provide a summary of the bidding to the originating entity 305, and/or perform other functions.

Providing the bid requirement in the message 355 for analysis by the facilitating entity 315 is advantageous to the originating entity 305 because the bid requirement may be data or information that the originating entity 305 does not want to be provided to the recipient entities 310. According to embodiments, the facilitating entity 315 can analyze the message 355 to determine how to modify the content of the message. For instance, the facilitating entity 315 can identify the bid requirement in the message 355 and determine that it is information to remove from the message 355 before sending to the recipient entities 310. Further, the facilitating entity 315 can determine that an open option (e.g., a blank field for soliciting bids from the recipient entities 310) is necessary to be added to the message 355.

Accordingly, the facilitating entity 315 can modify the message 355 in accordance with the analysis. As shown in FIG. 3, the modified message 360 can include a description of the item up for bid, as well as an open option field prompting for a bid value. The facilitating entity 315 can send the modified message 360 to each of the recipient entities 310. After receiving the modified message 360, each of the recipient entities 310 can input a bid for the described product. For example, as shown in FIG. 3, the recipient entities 310 input bids of $950 (361), $1,050 (362), and $1,100 (363).

The recipient entities 310 can provide responses to the modified message 360 (i.e., the bids 361, 362, 363) to the facilitating entity 315, and the facilitating entity 315 can analyze the bids 361, 362, 363 for fulfillment of the bid requirement and according to other parameters. As shown in FIG. 3, the bid 361 fails to meet the $1,000 reserve price and the bids 362 and 363 each exceed the $1,000 reserve price. Accordingly, the facilitating entity can determine that the winning bid that meets the bid requirement is bid 363, and can provide a bid result to the originating entity 305 that indicates the winning bid 363.

Although not shown in FIG. 3, if none of the bids 361, 362, 363 meet the bid requirement, the facilitating entity 315 can send an additional message to the recipient entities 310 that can, for example, indicate that the bid requirement is not met. In turn, the recipient entities can 310 can choose to increase their bids and send the new bids to the facilitating entity 315. In embodiments, the facilitating entity 315 can conduct multiple bid rounds until the bid requirement is met or until another predefined criteria is met. For example, the message 355 can specify that there will be a maximum of three (3) rounds of bids. It should be appreciated that other round facilitation and conversation termination criteria are envisioned. Further, it should be appreciated that similar conversation patterns are envisioned. For example, instead of a bid solicitation pattern, the originating entity 305 can submit a message that indicates for the facilitating entity 315 to conduct an open auction.

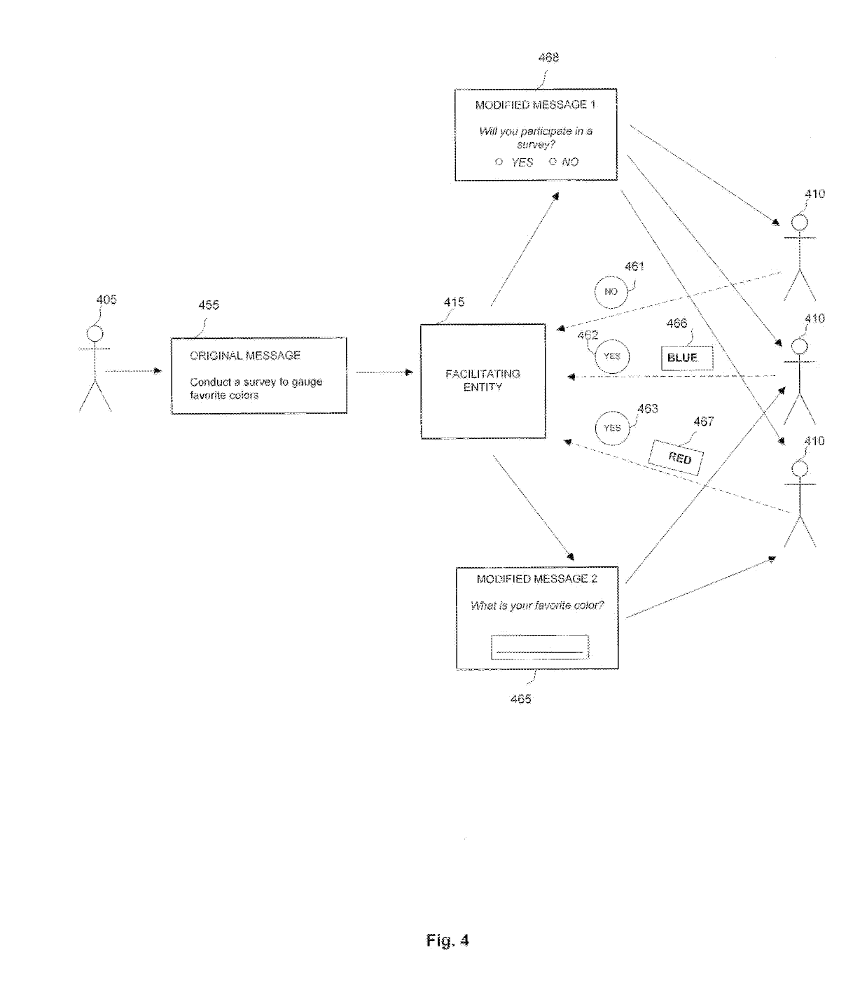

Referring to FIG. 4, depicted is an additional exemplary application of the functionalities as described herein. In particular, FIG. 4 depicts a survey pattern wherein an originating entity 405 wishes to conduct a survey with a group of recipient entities 410. Further, in conducting the survey, a facilitating entity 415 can modify styles of messages that it sends to the recipient entities 410 based on the round of message/response exchange.

As shown in FIG. 4, the originating entity 405 can provide an original message 455 to the facilitating entity 415. The original message 455 includes text indicating a desire to conduct a survey to gauge favorite colors. According to embodiments, the facilitating entity 415 can analyze the original message 455 to determine how to modify the original message 455. For example, the facilitating entity 415 can analyze the text of the original message 455 to determine that there could be two (2) total exchanges or rounds with the recipient entities 410. Particularly, one round can be to query the recipient entities 410 to determine if any are willing to participate in a survey and another round can be to ask the participating recipient entities 410 for their favorite color.

In response to the analysis, the facilitating entity 415 can modify the original message 455 to generate a modified message 460, and send the modified message 460 to the recipient entities 410. Each of the recipient entities can send responses to the modified message 460 back to the facilitating entity 415. For example, as shown in FIG. 4, one of the recipient entities 410 responded “NO” (461) while the other two recipient entities 410 responded “YES” (462, 463). Accordingly, the facilitating entity 415 can examine the responses to determine the two recipient entities 410 that are willing to participate in the survey, and can generate an additional modified message 465 to send to the two participating recipient entities 410.

Referring to FIG. 4, there are differences in the two modified messages 460, 465. Particularly, the format of the modified message 460 is an enumerated option that allows recipients to select one of the choices and the format of the additional modified message 465 is an open option that allows the user to input a response. In embodiments, the facilitating entity 415 can analyze the original message 455 to determine the formats of any modified messages that it sends to the recipient entities 410.

The two recipient entities 410 that receive the modified message 465 can send responses back to the facilitating entity 415. For example, as shown in FIG. 4, one of the recipient entities 410 responded “BLUE” (466) and another of the recipient entities 410 responded “RED” (467). In embodiments, the facilitating entity 415 can determine if a predefined criteria has been met and, if not, can provide further messages to any of the recipient entities 410. If the predefined criteria is met, the facilitating entity 415 can, for example, terminate the conversation, provide a summary of the responses received from the recipient entities 410 to the originating entity, or perform other actions.

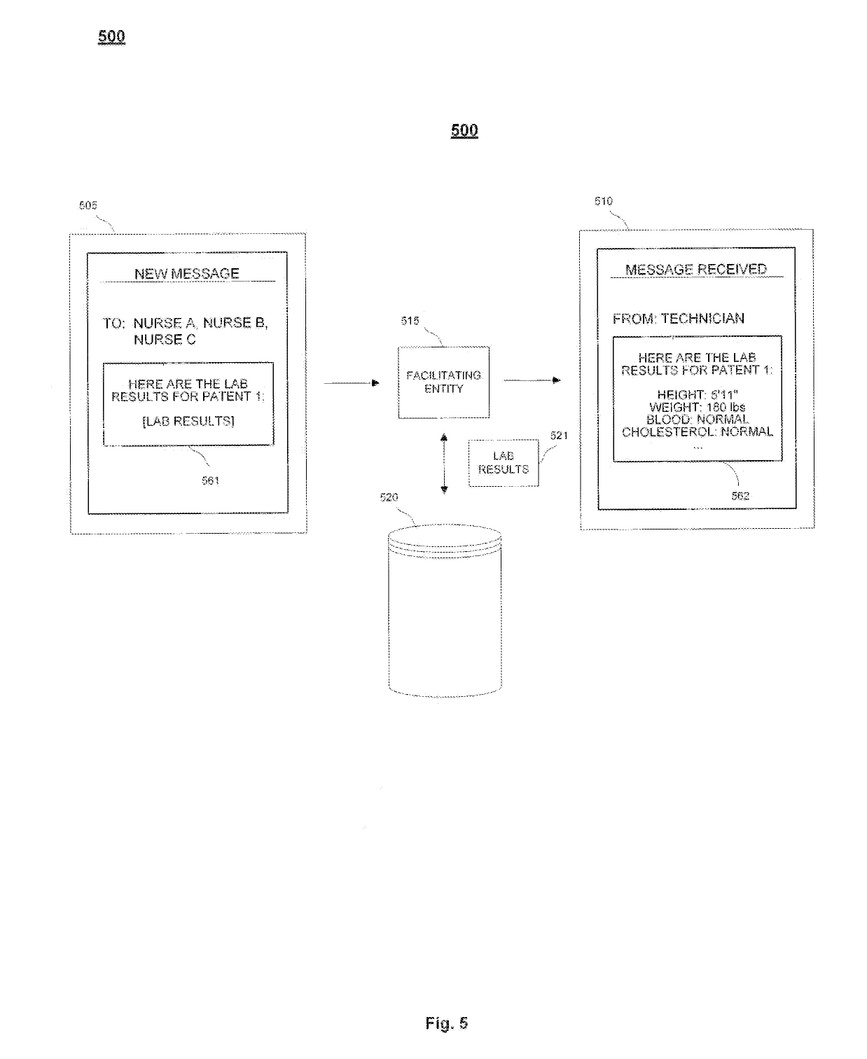

Referring to FIG. 5, depicted is a further exemplary application 500 of the facilitation functionality as discussed herein. In particular, the exemplary application 500 can relate to modifying message content with data accessible to a facilitating entity 515.

As shown in FIG. 5, the exemplary application 500 illustrates a user interface 505 associated with a device of an originating entity and a user interface 510 associated with a device of a recipient entity. It should be appreciated that the depicted user interfaces 505, 510 are merely exemplary and other layout, combinations, and implementations are envisioned. In implementations, the originating entity can create or compose a message to send to a plurality of recipient entities. For example, as shown in FIG. 5, the originating creates a message to send to Nurse A, Nurse B, and Nurse C. Further, a body 561 of the message can include text, pictures, links, and other. According to embodiments, the body 561 can also include a section that can include certain data, can indicate the need for further data, or can otherwise be left blank. For example, the body 561 as shown in FIG. 5 includes the text: “HERE ARE THE LAB RESULTS FOR PATIENT 1: [LAB RESULTS].”In particular, the [LAB RESULTS] text can correspond to a section of data that the originating entity may not have access to, may not know, or otherwise may not want to input into the body 561 of the message.

According to embodiments, the originating entity can send the message to the facilitating entity 515, which can analyze the message to determine how to modify the body 561 or other content of the message. In some cases, the facilitating entity 515 can perform a lexical analysis on the body 561 to identity relevant sections of the message that indicate the retrieval of further data or information. For example, the facilitating entity 515 can identify the [LAB RESULTS] and “PATIENT 1” sections of text of the body 561 and determine that it needs to retrieve the lab results associated with Patient 1, Particularly, the facilitating entity 515 can interface with a database 520 to retrieve associated lab results 521. It should be appreciated that the facilitating entity 515 can retrieve data from any local or remote data source. Further, in embodiments, the facilitating entity 515 can initiate an application, service, module, and/or the like to retrieve any needed data or information.

According to embodiments, the facilitating entity 515 can modify the body 561 of the message to append, insert, or otherwise include the lab results 521 into a message to send to the device 510 of the recipient entity. For example, according to the exemplary application 500, the recipient entity can be any of Nurse A, Nurse B, or Nurse C. Further, as shown in FIG. 5, a body 562 of the message that is sent to the device 510 includes the actual lab results 521 in the location originally specified by “[LAB RESULTS]” in the body 561 of the originating message. Accordingly, the facilitating entity 515 can modify the body 561 of the original message by appending data or information that it can access and retrieve from storage, from an application, via a network, or from any other location or component.

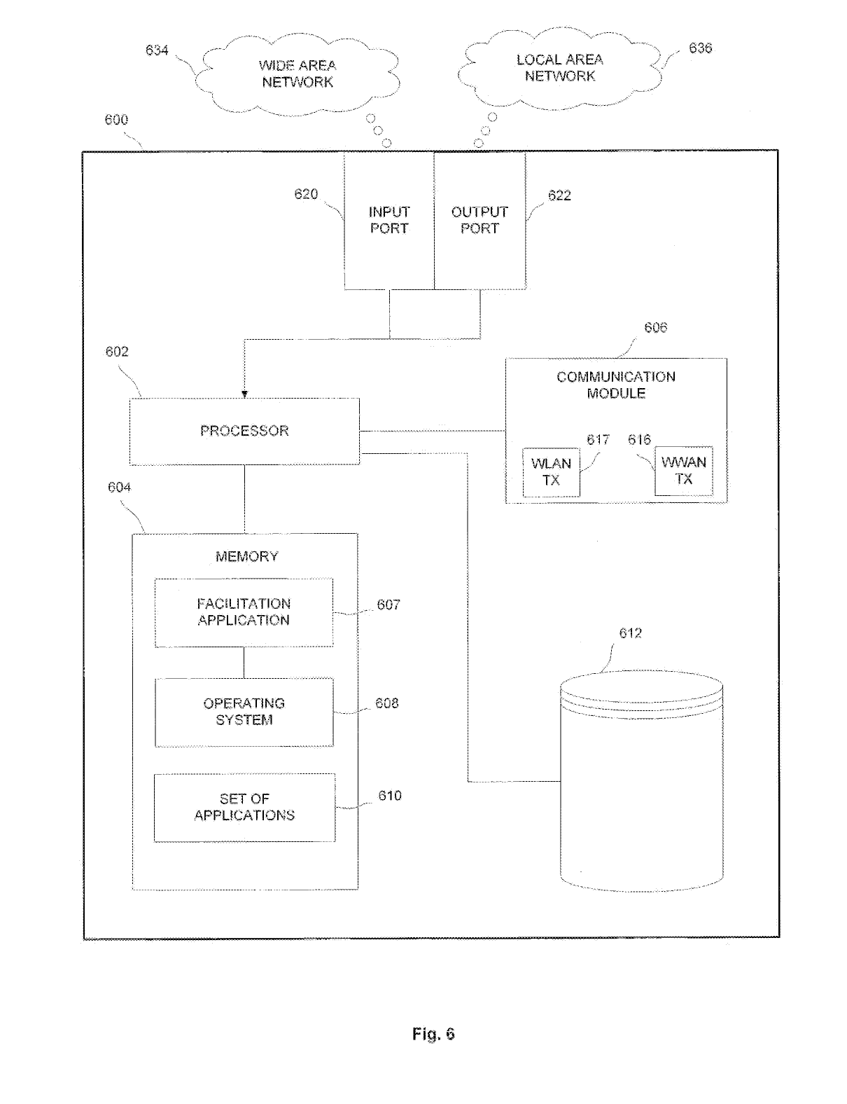

Referring to FIG. 6, depicted is an exemplary server 600 and components thereof. More particularly, the server 600 can be a combination of hardware and software components associated with the facilitating entity as discussed herein. It should be appreciated that FIG. 6 represents a generalized schematic illustration and that other hardware and software components can be added or existing components can be removed or modified.

As shown in FIG. 6, the server 600 can comprise a set of ports that can receive input signals or data from, or output signals or data to, other components of a communication environment, such as the originating entity 205 and the recipient entities 210 as discussed with respect to FIG. 2. More particularly, an input port 620 can receive cellular or other types of data from a wide area network 634 (such as various private or public networks) or a local area network 636 (such as a wireless local area network (WLAN)), and an output port 622 can output data to the wide area network 634 or the local area network 636. Although not shown in FIG. 6, the systems and methods envision other types of wired or wireless networks through which data can be communicated.

The server 600 can further comprise a processor(s) 602 communicating with a memory 604, such as electronic random access memory (RAM), or other forms of transitory or non-transitory computer readable storage mediums, operating under control of or in conjunction with an operating system 608. The operating system 608 can be any commercial, open-source, or proprietary operating system or platform. The processor 602 can communicate with a database 612, such as a database stored on a local hard drive. While illustrated as a local database in the server 600, the database 612 can be separate from the server 600.

The processor 602 can further communicate with a communication module 606, such as a wired or wireless data connection, which in turn communicates with the wide area network 634 and the local area network 636. In particular, the communication module 606 can comprise a WWAN transceiver 616 capable of communicating with the wide area network 634 and a WLAN transceiver 617 capable of communicating with the local area network 636. The set of ports 620, 622 of the server 600 can use the components of the communication module 606 to connect to any of the entities as discussed herein. For example, the input port 620 can receive a message from the originating entity 205 via the WWAN transceiver 616, and the output port 622 can send modified message data to the recipient entities 610 via the WWAN transceiver 616. The processor 602 can also communicate with a set of applications 610 that can be configured to execute control logic and perform data processing to perform the functions and techniques as discussed herein. For example, the set of applications 610 can comprise a facilitation application 607 that can support the functionalities of the message facilitation, as described herein. It should be appreciated that other applications 610 and functionalities thereof are envisioned.

While FIG. 6 illustrates the server 600 as a standalone system using a combination of hardware and software, the components of the server 600 can also be implemented as a software application or program capable of being executed by a conventional computer platform. Likewise, the components of the server 600 can also be implemented as a software module or program module capable of being incorporated in other software applications and programs. In either case, the components of the server 600 can be implemented in any type of conventional proprietary or open-source computer language.

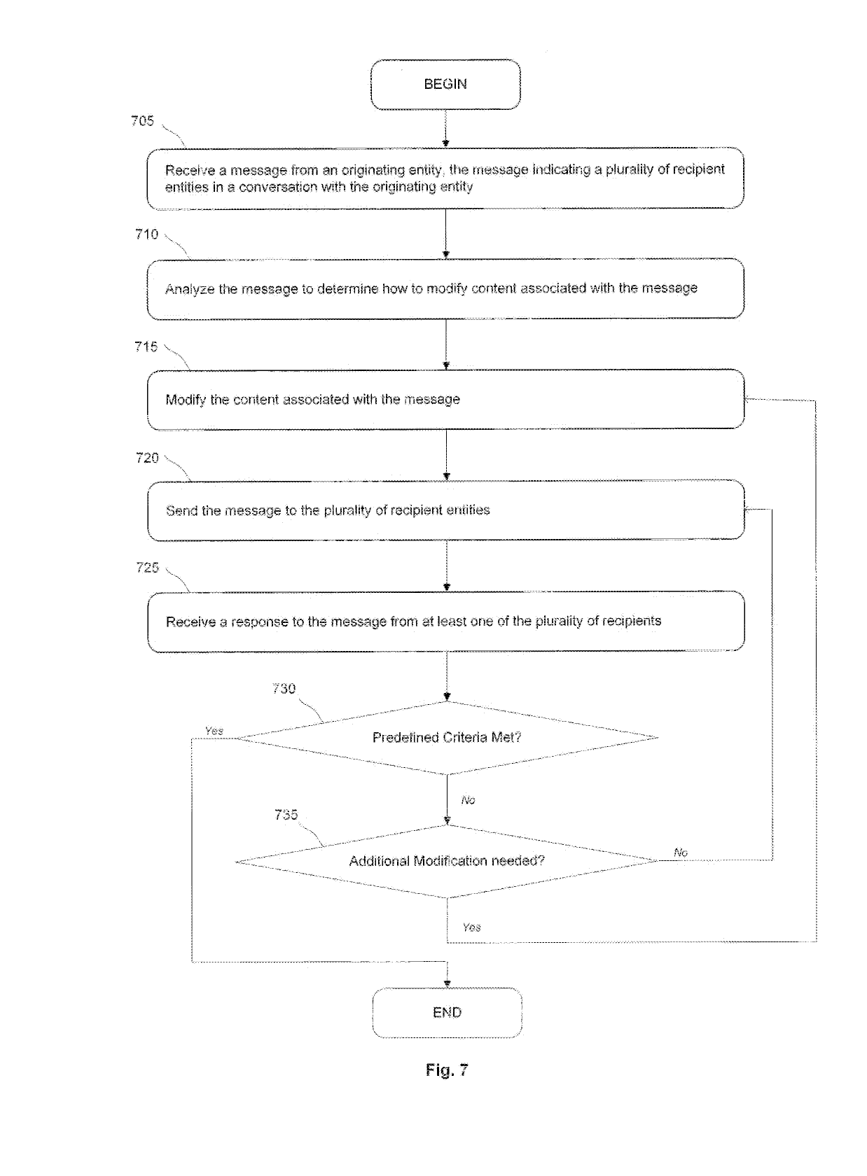

FIG. 7 Is a flowchart of a method 700 for a facilitating entity (such as the facilitating entity 215 as discussed with respect to FIG. 2) to facilitate the delivery of a message intended for a plurality of recipient entities. More particularly, the method 700 relates to the facilitating entity modifying content associated with the message prior to sending the message to the plurality of recipient entities.

The method 700 begins with the facilitating entity receiving 70S a message from an originating entity, the message indicating a plurality of recipient entities. Particularly, the originating entity can be in a conversation with the plurality of recipient entities and, in some cases, the metadata of the message can indicate the plurality of recipient entities. The facilitating entity analyzes 710 the message to determine how to modify content associated with the message. For example, the facilitating entity can determine that the message priority needs to be modified, that certain metadata needs to be added to or removed from the message, that the body of the message needs to be modified, or that other content modifications are needed.

The facilitating entity modifies 715 the content associated with the message according To the analysis and sends 720 the message to the plurality of recipient entities. It should be appreciated that sending the message can be accomplished via any type of communication protocol. The facilitating entity receives 725 a response to the message from at least one of the plurality of recipient entities. For example, the message sent to the plurality of recipient entities can be a survey including several options, and the response can be a selection of one of the options. It should be appreciated that other various message and response styles or formats are envisioned.

The facilitating entity determines 730 if a predefined criteria has been met. For example, if the message sent to the plurality of recipient entities is a survey, the predefined criteria can be met when the facilitating entity receives three or more responses. For further example, if the message sent to the plurality of recipient entities is a request for bids, then predefined criteria can be met when the facilitating entity receives a bid that fulfills a bid requirement, such as meeting a minimum amount. If the predefined criteria is met (“YES”), then processing can end, repeat, or return to any previous functionality. If the predefined criteria is not met (“NO”), the facilitating entity determines 735 if any additional modification to the message is needed. For example, additional modification may be needed if the facilitating entity identifies or determines additional content to send to the plurality of recipient entities. If additional modification is needed (“YES”), processing can proceed to 715 where the facilitating entity further modifies content of the message. If no additional modification is needed (“NO”), then processing can optionally proceed to 720 where the facilitating entity re-sends the message to one or more of the plurality of recipient entities. In some cases, the facilitating entity does not re-send the message but instead waits to receive more responses.

Thus, it should be clear from the preceding disclosure that the system and method effectively and efficiently manages a message exchange between an originating entity and a plurality of recipient entities. The system and method advantageously allows an originating entity to compose a message that can be modified by a facilitating entity according to various parameters and analyses. Further, the system and method can facilitate message and response exchange between the facilitating entity and the recipient entities before the facilitating entity reports any results to the originating entity.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. A method of managing a conversation between an originating entity and a plurality of recipient entities, the method comprising:
receiving, at a first computer, a message from the originating entity, the message indicating the plurality of recipient entities;
analyzing, by the first computer, the message to determine how to modify content associated with the message;
modifying, using the first computer, the content associated with the message according to the analyzing; and
sending the message with the content that was modified to the plurality of recipient entities.

2. The method of claim 1, wherein analyzing the message to determine how to modify the content associated with the message comprises:
querying an entity to modify the content associated with the message; and
receiving, from the entity, a modification to the content associated with the message.

3. The method of claim 1, further comprising:
receiving a response to the message from at least one of the plurality of recipients;
in response to receiving the response, determining whether a predefined criteria is met;
if the predefined criteria is not met:
further modifying the content associated with the message, and
sending the message with the content that was further modified to the plurality of recipient entitles; and
if the predefined criteria is met:
terminating the conversation.

4. The method of claim 1, wherein the message comprises a bid requirement for soliciting bids from the plurality of recipient entities and wherein analyzing the message to determine how to modify the content associated with the message comprises:
determining a bid request corresponding to the bid requirement, wherein sending the message with the content that was modified comprises sending the bid request to the plurality of recipient entities.

5. The method of claim 1, wherein the message relates to a query for soliciting responses from the plurality of recipient entities and wherein analyzing the message to determine how to modify the content associated with the message comprises:
determining a format for the query, wherein the format is at least one of an enumerated option or an open option, and wherein the sending the message with the content that was modified comprises sending, to the plurality of recipient entities, the query in the format that was determined.

6. The method of claim 5, further comprising:
receiving the responses from at least some of the plurality of recipient entities;
analyzing the responses to determine an additional format for an additional query; and
sending, to the plurality of recipient entities, the additional query in the additional format.

7. The method of claim 1, wherein modifying the content associated with the message comprises:
modifying at least one of a body of the message or metadata of the message.

8. The method of claim 1, wherein sending the message comprises:
sending the message to an additional server, wherein the additional server further modifies the content associated with the message and sends the message with the content that was further modified to the plurality of recipient entities.

9. The method of claim 1, wherein analyzing the message to determine how to modify the content associated with the message comprises:
examining the message to identify a section corresponding to information needed to insert into the message; and
retrieving the information needed to insert into the message.

10. A system for managing a conversation between an originating entity and a plurality of recipient entities, the system comprising:
a server comprising a communication module for sending and receiving messages associated with the conversation; and
a processor coupled to the server and configured to perform operations comprising:
receiving a message from the originating entity via the communication module, the message indicating the plurality of recipient entities;
analyzing the message to determine how to modify content associated with the message;
modifying the content associated with the message according to the analyzing; and
sending the message with the content that was modified to the plurality of recipient entities via the communication module.

11. The system of claim 10, further comprising a user interface in communication with the processor, and wherein analyzing the message to determine how to modify the content associated with the message comprises:
querying a user, via the user interface, to modify the content associated with the message; and
receiving, from the user via the user interface, a modification to the content associated with the message.

12. The system of claim 10, wherein the processor is further configured to perform operations comprising:
receiving a response to the message from at least one of the plurality of recipients;
in response to receiving the response, determining whether a predefined criteria is met;
if the predefined criteria is not met:
further modifying the content associated with the message, and
sending the message with the content that was further modified to the plurality of recipient entities; and
if the predefined criteria is met:
terminating the conversation.

13. The system of claim 10, wherein the message comprises a bid requirement for soliciting bids from the plurality of recipient entities and wherein analyzing the message to determine how to modify the content associated with the message comprises:
determining a bid request corresponding to the bid requirement, wherein sending the message with the content that was modified comprises sending the bid request to the plurality of recipient entities.

14. The system of claim 10, wherein the message relates to a query for soliciting responses from the plurality of recipient entities and wherein analyzing the message to determine how to modify the content associated with the message comprises:
determining a format for the query, wherein the format is at least one of an enumerated option or an open option, and wherein the sending the message with the content that was modified comprises sending, to the plurality of recipient entities, the query in the format that was determined.

15. The system of claim 10, further comprising an additional server, and wherein sending the message comprises:
sending the message to the additional server, wherein the additional server further modifies the content associated with the message and sends the message with the content that was further modified to the plurality of recipient entities.

16. The system of claim 10, further comprising a database configured to store information, wherein analyzing the message to determine how to modify the content associated with the message comprises:
examining the message to identity a section corresponding to additional content needed to insert into the message; and
retrieving, from the information stored in the database, the additional content needed to insert into the message.

17. A non-transitory computer readable medium comprising computer instructions embodied thereon to cause a processor of a device to:
receive, at the processor, a message from an originating entity, the message indicating a plurality of recipient entities;
analyze, by the processor, the message to determine how to modify content associated with the message;
modify, using the processor, the content associated with the message according to the analyzing; and
send the message with the content that was modified to the plurality of recipient entities.

18. The non-transitory computer readable medium of claim 17, wherein analyzing the message to determine how to modify the content associated with the message comprises:
querying an entity to modify the content associated with the message; and
receiving, from the entity, a modification to the content associated with the message.

19. The non-transitory computer readable medium of claim 17, wherein modifying the content associated with the message comprises:
modifying at least one of a body of the message or metadata of the message.

20. The non-transitory computer readable medium of claim 17, wherein analyzing the message to determine how to modify the content associated with the message comprises:
examining the message to identify a section corresponding to information needed to insert into the message; and
retrieving the information needed to insert into the message.
